(19) United States
(12) Patent Application Publication
(10) Pub. No.: US 2014/0043482 A1
(43) Pub. Date: Feb. 13, 2014

(54) VEHICLE SECURITY SYSTEM

(71) Applicant: CHUI-MIN CHIU, Hsinchu City (TW)

(72) Inventor: CHUI-MIN CHIU, Hsinchu City (TW)

(21) Appl. No.: 13/569,161

(22) Filed: Aug. 7, 2012

(51) Int. Cl. H04N 7/18

(52) U.S. Cl. 348/148; 348/E07.085

(57) ABSTRACT

The vehicle security system contains an image recorder module, a navigation and positioning module, a storage module, at least a security and surveillance module, and a central processing unit. The image recorder module captures at least a target vehicle's image. The navigation and positioning module produces a location coordinate. The storage module stores an electronic map. The security and surveillance module performs identification to the image. The central processing unit receives the image and then produces and stores at least an identification parameter in the storage module. The security and surveillance module then determines if the identification parameter satisfies a preset alarm condition. If the preset alarm condition is satisfied, a warning signal is produced and delivered to the central processing unit which, according to the location coordinate and the electronic map, produces navigation guidance and warning message.

### TECHNICAL FIELD OF THE INVENTION

The present invention generally relates to vehicle security systems, and especially relates to a vehicle security system capable of proactive detection and effective early warning.

### DESCRIPTION OF THE PRIOR ART

A vehicle video recorder is a device installed in automobiles that records video to create recorded evidence of a traffic accident for evaluating the cause of the accident and the responsible party. On the other hand, the purpose of the global positioning system (GPS) provides accurate information about location, speed, and time of a vehicle. Currently, most automobiles have these two functions built-in.

However, these two functions cannot provide proactive assistance to the driver to handle situations like being followed, reckless driver, unclear road condition, etc. Therefore, how to integrate these two functions into a vehicle security system capable of proactive detection and effective early warning becomes an important topic.

### SUMMARY OF THE INVENTION

Therefore, a novel vehicle security system is provided herein, which contains an image recorder module, a navigation and positioning module, a storage module, at least a security and surveillance module, and a central processing unit. The image recorder module captures at least a target vehicle's image. The navigation and positioning module produces a location coordinate. The storage module stores an electronic map. The security and surveillance module performs identification to the image. The central processing unit is coupled to the image recorder module, navigation and positioning module, storage module, and security and surveillance module.

The present invention also provides a vehicle security method. Firstly, an image recorder module is used to capture an image of at least a target vehicle. Then, the captured image is processed by a central processing unit to produce and store an identification parameter in a storage module. Subsequently, the identification parameter is determined by a security and surveillance module to see if a preset warning condition is satisfied and, if yes, to produce a warning signal to the central processing unit. Finally, a location coordinate is received by the central processing unit and, based on an electronic map stored in the storage module, navigation guidance and warning message is produced by the central processing unit.

Compared to conventional vehicle security system, the present invention not only maintain the recording function of a vehicle video recorder and the navigation function of a global positioning system, but also provide proactive detection and effective early warning.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing the various functional units of a vehicle security system according to an embodiment of the present invention.

FIG. 2 is a schematic diagram showing a preset mileage range adopted by the vehicle security system of FIG I.

FIG. 3 is a schematic diagram showing a focused range of a target vehicle determined by the vehicle security system of FIG. 1.

FIG. 4 is a schematic diagram showing another focused range of a target vehicle determined by the vehicle security system of FIG. 1.

FIG. 5 is a schematic diagram showing the various solutions provided by the vehicle security system of FIG. 1.

FIG. 6 is a flow diagram showing the steps of a method according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

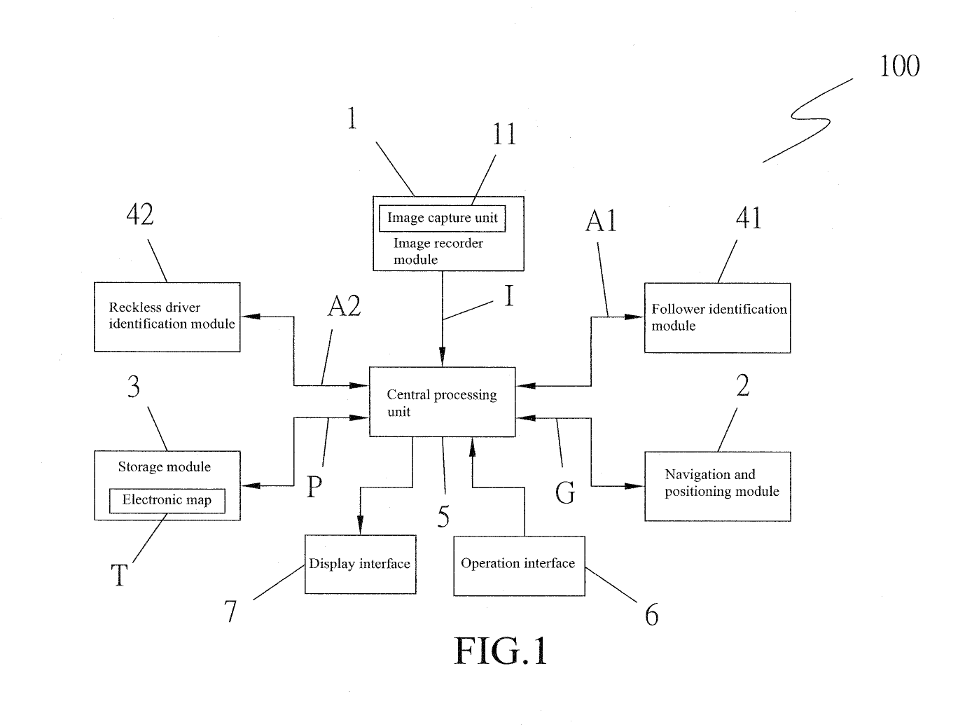

As shown in FIG. 1, a vehicle security system 100 according to an embodiment of the present invention contains an image recorder module 1, a navigation and positioning module 2, a storage module 3, a security and surveillance module, and a central processing unit 5. The image recorder module 1 captures at least a target vehicle's image I. The navigation and positioning module 2 produces a location coordinate G. The storage module stores an electronic map T. The security and surveillance module performs identification to the image I. The central processing unit 5 receives the image I and then produces and stores at least an identification parameter P in the storage module 3. The security and surveillance module then determines if the identification parameter P satisfies a preset alarm condition. If the preset alarm condition is satisfied, a warning signal is produced and delivered to the central processing unit 5 which in turn, according to the location coordinate G and the electronic map T, produces navigation guidance and warning message.

The image recorder module 1 contains at least an image capture unit 11 positioned at an appropriate place in a subject vehicle where the vehicle security system 100 is installed. The central processing unit 5 is further coupled to an operation interface 6 and a display interface 7. The operation interface 6 allows a driver of the subject vehicle to conduct function selection and control. The display interface 7 notifies the driver about the warning message issued from the central processing unit 5.

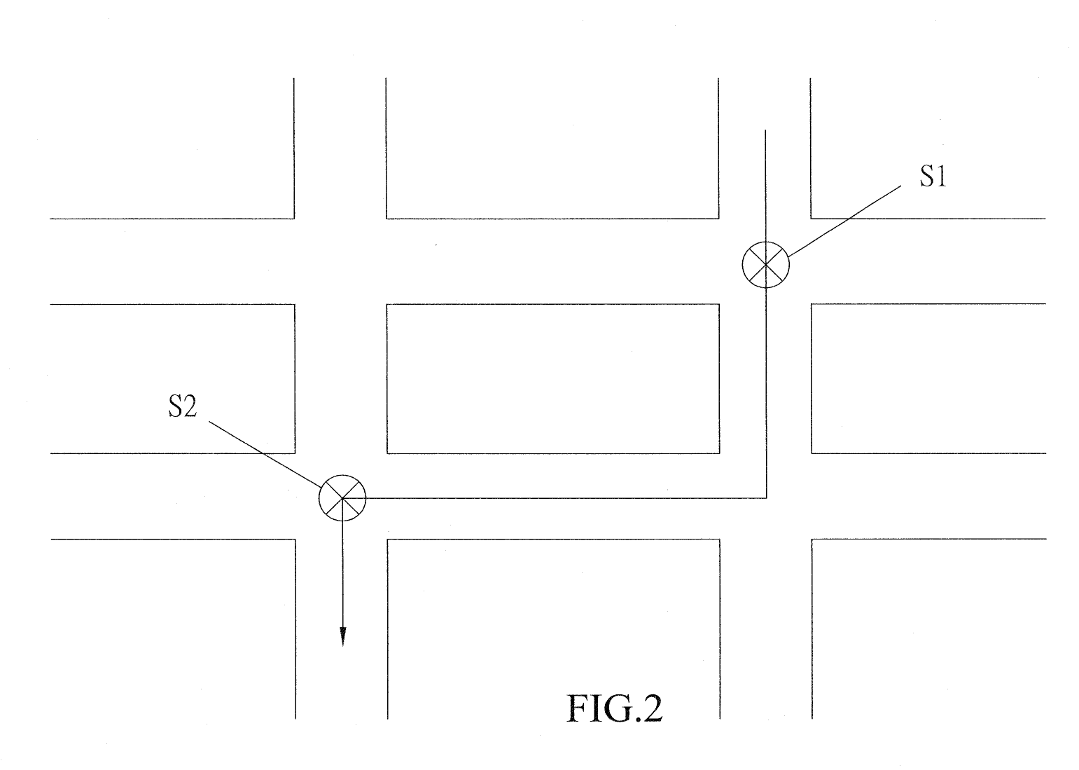

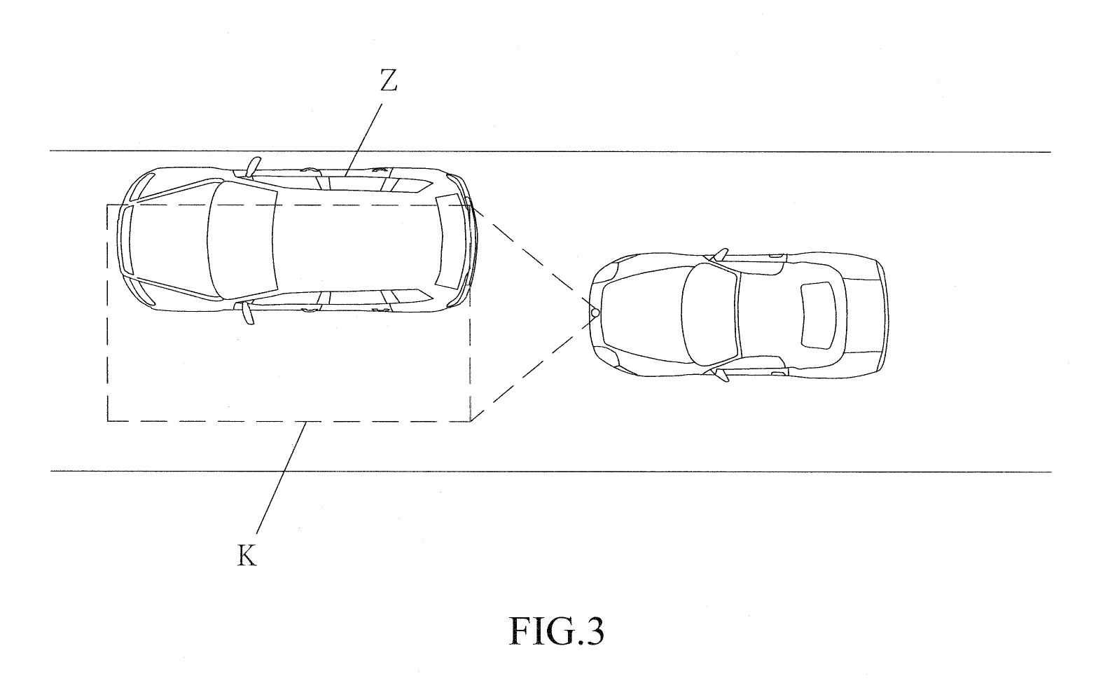

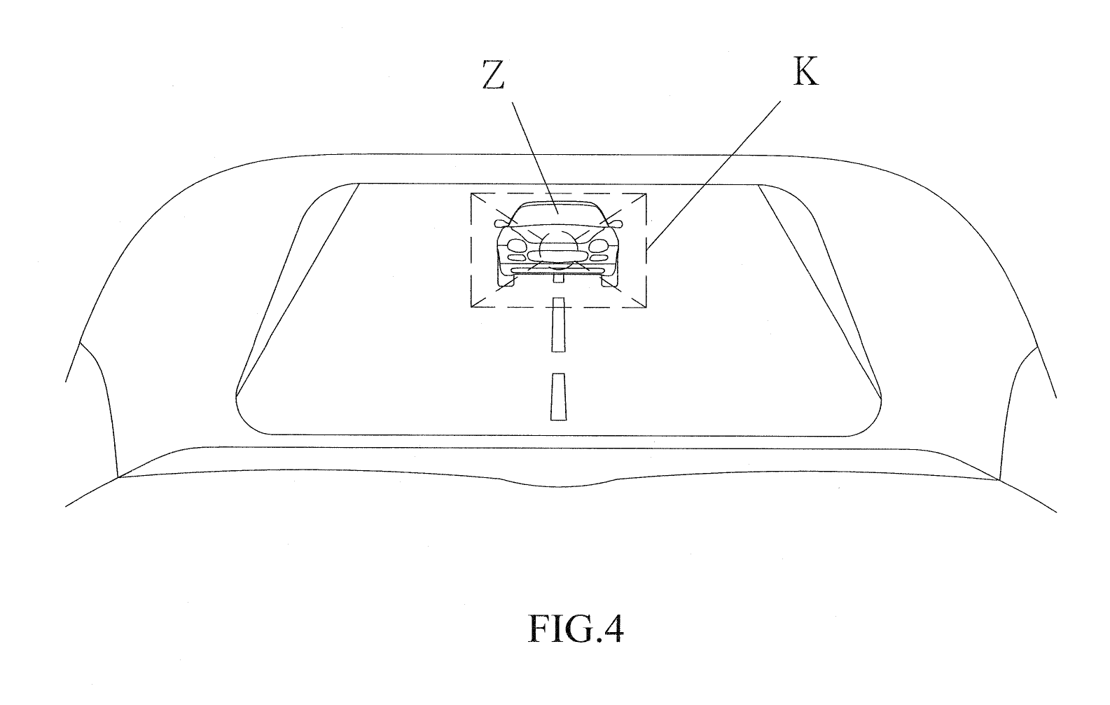

As shown in FIGS. 1 to 4, the security and surveillance module contains a follower identification module 41 and reckless driver identification module 42. The follower identification module 41 determines that the subject vehicle is being followed if the image I of a target vehicle is repeatedly captured around the subject vehicle within a preset mileage range (i.e., from a starting point Si to a destination point S2). A warning signal A1 is produced and sent to the central processing unit 5. The vehicle security system can be installed on multiple subject vehicles so as to provide more comprehensive surveillance and thereby a greater degree of security.

The reckless driver identification module 42 conducts focusing on the image I of a target vehicle Z to determine a focused range K and then, based on the target vehicle Z's focal length, speed, and whether it is out of focus, further determines if the target vehicle Z is driven by a reckless driver if the target vehicle Z's movement satisfies a preset warning condition. Then, a warning signal A2 is produced and sent to the central processing unit 5. The image I can be one of the recognizable images including, for example, the license plate, lamp color, and automobile module. The focusing conducted can be a single-point focusing, multiple-point focusing, or high-speed focusing, etc.

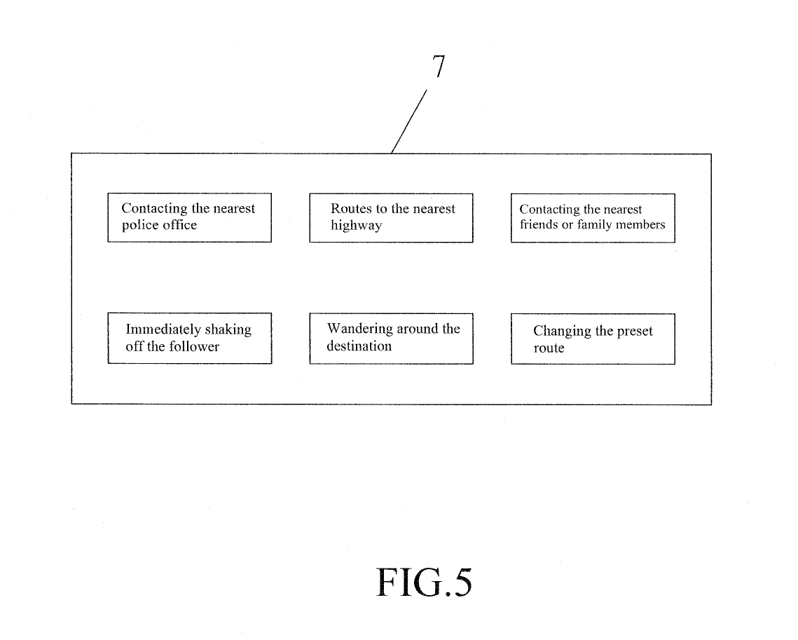

As shown in FIGS. 1 to 5, after the vehicle security system 100 detects that a reckless driver is around or the subject vehicle is being followed, the navigation and positioning module 2 display warning message and various solutions on the display interface 7 such as contacting the nearest police office, routes to the nearest highway, contacting the nearest friends or family members, immediately shaking off the follower, wandering around the destination, changing the preset route, etc. so as to avoid the potential hazard.

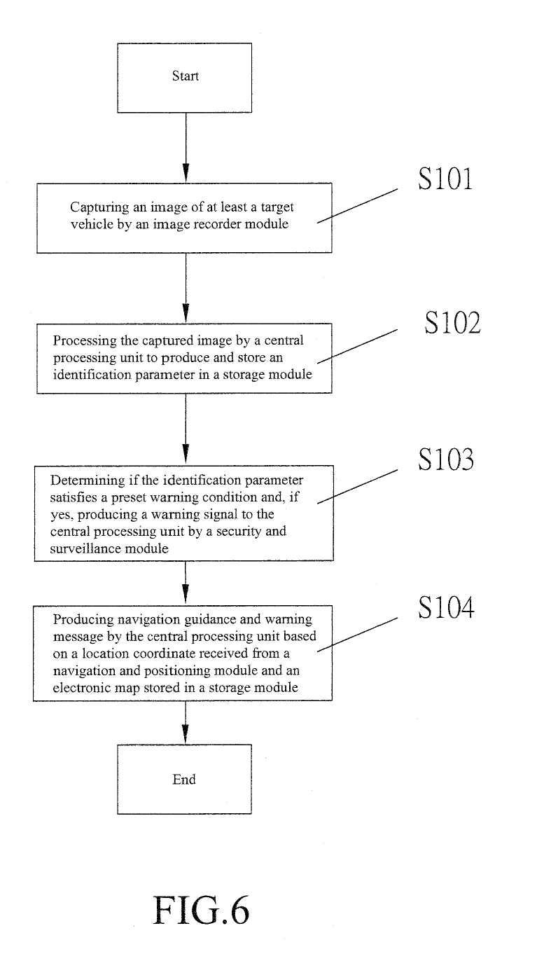

As shown in FIG. 6, a vehicle security method of the present invention contains the following steps. In step S101, an image recorder module is used to capture an image of at least a target vehicle. In step S102, the captured image is processed by a central processing unit to produce and store an identification parameter in a storage module. In step S103, the identification parameter is determined by a security and surveillance module to see if a preset warning condition is satisfied and, if yes, to produce a warning signal to the central processing unit. In step S104, a location coordinate is received by the central processing unit and, based on an electronic map stored in the storage module, navigation guidance and warning message is produced by the central processing unit.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A vehicle security system installed in a subject vehicle, comprising:
an image recorder module capturing at least a target vehicle's image;
a navigation and positioning module producing a location coordinate;
a storage module storing an electronic map;
at least a security and surveillance module performing identification to the image; and
a central processing unit coupled to the image recorder module, navigation and positioning module, storage module, and security and surveillance module;
wherein the central processing unit receives the image and then produces and stores at least an identification parameter in the storage module; the security and surveillance module then determines if the identification parameter satisfies a preset alarm condition; and, if the preset alarm condition is satisfied, the security and surveillance module produces a warning signal to the central processing unit which in turn, according to the location coordinate and the electronic map, produces navigation guidance and warning message.

2. The vehicle security system according to claim 1, wherein the image recorder module comprises an image capture unit positioned at an appropriate place in the subject vehicle.

3. The vehicle security system according to claim 1, wherein the security and surveillance module comprises a follower identification module determining that the subject vehicle is being followed if the image of a target vehicle is repeatedly captured around the subject vehicle within a preset mileage range.

4. The vehicle security system according to claim 1, wherein the security and surveillance module comprises a reckless driver identification module that conducts focusing on the image of a target vehicle and then, based on the target vehicle's focal length, speed, and out of focus or not, determines if the target vehicle is driven by a reckless driver.

5. The vehicle security system according to claim 1, further comprising an operation interface and a display interface, both coupled to the central processing unit wherein the operation interface allows a driver of the subject vehicle to conduct function selection and control;
and the display interface notifies the driver about the warning message issued from the central processing unit.

6. A vehicle security method for a subject vehicle comprising the steps of:
capturing an image of at least a target vehicle by an image recorder module;
processing the captured image by a central processing unit to produce and store an identification parameter in a storage module;
determining if the identification parameter satisfies a preset warning condition and, if yes, producing a warning signal to the central processing unit by a security and surveillance module; and
producing navigation guidance and warning message by the central processing unit based on a location coordinate received from a navigation and positioning module and an electronic map stored in a storage module.

7. The vehicle security method according to claim 6, wherein the security and surveillance module comprises a follower identification module determining that the subject vehicle is being followed if the image of a target vehicle is repeatedly captured around the subject vehicle within a preset mileage range.

8. The vehicle security method according to claim 6, wherein the security and surveillance module comprises a reckless driver identification module that conducts focusing on the image of a target vehicle and then, based on the target vehicle's focal length, speed, and out of focus or not, determines if the target vehicle is driven by a reckless driver.
